(19) United States
(12) Patent Application Publication
(10) Pub. No.: US 2009/0134963 A1
(43) Pub. Date: May 28, 2009

(54) FLEXIBLE MAGNETIC SHEET SYSTEMS

(76) Inventors: Orval D. Ogden, JR., Marietta, OH (US); Tom Love, Marietta, OH (US); Jeff Knowlton, Marietta, OH (US)

Correspondence Address: Stoneman Volk Patent Group, 3770 NORTH 7TH STREET, Suite 100, PHOENIX, AZ, 85014, US

(21) Appl. No.: 12/276,094

(22) Filed: Nov. 21, 2008

Related U.S. Application Data
(60) Provisional application No. 60/990,246, filed on Nov. 26, 2007.
(60) Provisional application No. 61/045,569, filed on Apr. 16, 2008.

(51) Int. Cl. H01F 3/02

(52) U.S. Cl. 335/297

(57) ABSTRACT

Flexible magnetic sheets made with high-energy strontium ferrite, such as to decrease thickness with maintaining a strong magnetic energy (over one Megagause-Oersted) as well as flexibility.

### CROSS-REFERENCE TO RELATED APPLICATION

The present application is related to and claims priority from prior provisional application Ser. No. 60/990,246, filed Nov. 26, 2007, entitled “PRINTABLE FLEXIBLE MAGNETIC LAMINATE SYSTEMS”, and is related to and claims priority from prior provisional application Ser. No. 61/045,569, filed Apr. 16, 2008, entitled “FLEXIBLE MAGNETIC SHEET SYSTEMS”, the contents of both of which are incorporated herein by this reference and are not admitted to be prior art with respect to the present invention by the mention in this cross-reference section.

### BACKGROUND

This invention relates to providing a system for improved flexible magnetic sheets. More particularly, this invention relates to providing a system for making thin flexible magnetic sheets.

Typically, flexible magnetic sheets, if made thinner, lose a significant amount of their magnetic energy to the point where they may not even hold their own weight against a vertical magnetically-compatible surface. Additionally, if such thinner flexible magnetic sheets have increased magnetic particles to overcome the deficiency of magnetic energy, they become brittle and no longer function as “flexible”.

Thus, there is a need for improved providing of thin flexible sheets having higher potential for magnetic energy.

### OBJECTS AND FEATURES OF THE INVENTION

A primary object and feature of the present invention is to provide a flexible magnetic sheet system overcoming the above-mentioned problems.

It is a further object and feature of the present invention to provide such a flexible magnetic sheet system making flexible magnetic sheets thinner than 15 mils.

It is yet a further object and feature of the present invention to provide such a flexible magnetic sheet system making flexible magnetic sheets with high-energy strontium ferrite.

A further primary object and feature of the present invention is to provide such a system that is efficient, inexpensive, and handy.

Other objects and features of this invention will become apparent with reference to the following descriptions.

### SUMMARY OF THE INVENTION

In accordance with a preferred embodiment hereof, this invention provides a magnetizable-sheet laminate system comprising: at least one magnetizable laminate layer; at least one printable laminate layer; and at least one attacher laminate layer structured and arranged to attach such at least one magnetizable laminate layer with such at least one printable laminate layer; wherein such magnetizable-sheet laminate system comprises at least one laminate less than about 20 mil thick. Moreover, it provides such a magnetizable-sheet laminate system wherein such at least one magnetizable laminate layer comprises at least one thickness less than about 15 mils thick.

Additionally, it provides such a magnetizable-sheet laminate system wherein such at least one printable laminate layer comprises at least one matte finish. Also, it provides such a magnetizable-sheet laminate system wherein such at least one printable laminate layer comprises at least one high-gloss finish. In addition, it provides such a magnetizable-sheet laminate system wherein such at least one printable laminate layer comprises at least one gloss finish. And, it provides such a magnetizable-sheet laminate system wherein such at least one printable laminate layer comprises at least one wipe-off finish.

Further, it provides such a magnetizable-sheet laminate system wherein such at least one printable laminate layer comprises vinyl. Even further, it provides such a magnetizable-sheet laminate system wherein such at least one printable laminate layer comprises at least one matte finish. Moreover, it provides such a magnetizable-sheet laminate system wherein such at least one printable laminate layer comprises at least one high-gloss finish. Additionally, it provides such a magnetizable-sheet laminate system wherein such at least one printable laminate layer comprises at least one gloss finish. Also, it provides such a magnetizable-sheet laminate system wherein such at least one printable laminate layer comprises at least one wipe-off finish.

In addition, it provides such a magnetizable-sheet laminate system wherein such at least one laminate comprises at least one width of about two feet. And, it provides such a magnetizable-sheet laminate system wherein such at least one laminate comprises at least one roll. Further, it provides such a magnetizable-sheet laminate system wherein such at least one magnetizable laminate layer comprises strontium ferrite. Even further, it provides such a magnetizable-sheet laminate system wherein such at least one magnetizable laminate layer, by weight, comprises about 91% strontium ferrite.

Moreover, it provides such a magnetizable-sheet laminate system wherein such at least one magnetizable laminate layer comprises at least one binder material structured and arranged to bind together components of such at least one magnetizable laminate layer. Additionally, it provides such a magnetizable-sheet laminate system wherein such at least one binder material comprises: chlorosulfonated polyethylene rubber; polyisobutylene; and ethylene vinyl acetate. Also, it provides such a magnetizable-sheet laminate system wherein such at least one binder material, by weight of such at least one magnetizable laminate layer, comprises: about 3.6% chlorosulfonated polyethylene rubber; about 3% polyisobutylene; and about 2.2% ethylene vinyl acetate.

In accordance with another preferred embodiment hereof, this invention provides a magnetizable-sheet system comprising: at least one homogenous sheet comprising at least one binder material structured and arranged to bind together components of such at least one homogenous sheet, and at least one plurality of magnetizable particles held by such at least one binder material, wherein such at least one plurality of magnetizable particles consist essentially of strontium ferrite, and wherein such at least one plurality of magnetizable particles when magnetized comprise a magnetic energy of greater than one Megagauss-Oersted. In addition, it provides such a magnetizable-sheet system wherein such at least one homogenous sheet comprises at least one thickness less than about 15 mils thick.

And, it provides such a magnetizable-sheet system wherein such at least one binder material comprises: chlorosulfonated polyethylene rubber; polyisobutylene; and ethylene vinyl acetate. Further, it provides such a magnetizable-sheet system wherein such at least one binder material, by weight of such at least one homogeneous sheet, comprises: about 3.6% chlorosulfonated polyethylene rubber; about 3% polyisobutylene; and about 2.2% ethylene vinyl acetate. Even further, it provides such a magnetizable-sheet system wherein such at least one homogeneous sheet, by weight, comprises about 91% strontium ferrite. Moreover, it provides such a magnetizable-sheet system wherein such at least one homogenous sheet comprises at least one width of about two feet. Additionally, it provides such a magnetizable-sheet system wherein such at least one homogenous sheet comprises at least one roll.

In accordance with another preferred embodiment hereof, this invention provides a magnetizable-sheet laminate system comprising: at least one magnetizable laminate layer comprising at least one binder material structured and arranged to bind together components of such at least one magnetizable laminate layer, at least one plurality of magnetizable particles held by such at least one binder material, wherein such at least one plurality of magnetizable particles consist essentially of strontium ferrite, and wherein such at least one plurality of magnetizable particles when magnetized comprise a magnetic energy of greater than one Megagauss-Oersted; at least one printable laminate layer; and at least one attacher laminate layer structured and arranged to attach such at least one magnetizable laminate layer with such at least one printable laminate layer; wherein such magnetizable-sheet laminate system comprises at least one laminate less than about 20 mils thick. Also, it provides such a magnetizable-sheet laminate system wherein such at least one magnetizable laminate layer comprises at least one thickness less than about 15 mils thick.

In addition, it provides such a magnetizable-sheet laminate system wherein such at least one printable laminate layer comprises at least one matte finish. And, it provides such a magnetizable-sheet laminate system wherein such at least one printable laminate layer comprises at least one high-gloss finish. Further, it provides such a magnetizable-sheet laminate system wherein such at least one printable laminate layer comprises at least one gloss finish. Even further, it provides such a magnetizable-sheet laminate system wherein such at least one printable laminate layer comprises at least one wipe-off finish.

Moreover, it provides such a magnetizable-sheet laminate system wherein such at least one printable laminate layer comprises vinyl. Additionally, it provides such a magnetizable-sheet laminate system wherein such at least one printable laminate layer comprises at least one matte finish. Also, it provides such a magnetizable-sheet laminate system wherein such at least one printable laminate layer comprises at least one high-gloss finish. In addition, it provides such a magnetizable-sheet laminate system wherein such at least one printable laminate layer comprises at least one gloss finish. And, it provides such a magnetizable-sheet laminate system wherein such at least one printable laminate layer comprises at least one wipe-off finish.

Further, it provides such a magnetizable-sheet laminate system wherein such at least one laminate comprises at least one width of about two feet. Even further, it provides such a magnetizable-sheet laminate system wherein such at least one laminate comprises at least one roll. Moreover, it provides such a magnetizable-sheet laminate system wherein such at least one magnetizable laminate layer, by weight, comprises about 91% strontium ferrite.

Additionally, it provides such a magnetizable-sheet laminate system wherein such at least one binder material comprises: chlorosulfonated polyethylene rubber; polyisobutylene; and ethylene vinyl acetate. Also, it provides such a magnetizable-sheet laminate system wherein such at least one binder material, by weight of such at least one magnetizable laminate layer, comprises: about 3.6% chlorosulfonated polyethylene rubber; about 3% polyisobutylene; and about 2.2% ethylene vinyl acetate. In addition, it provides such a magnetizable-sheet laminate system wherein such at least one magnetizable laminate layer, by weight, comprises about 91% strontium ferrite.

And, it provides such a magnetizable-sheet laminate system wherein such at least one magnetizable laminate layer comprises at least one thickness less than about 15 mils thick. Further, it provides such a magnetizable-sheet laminate system wherein such at least one laminate comprises at least one width of about two feet. Even further, it provides such a magnetizable-sheet laminate system wherein such at least one laminate comprises at least one roll. Even further, it provides such a magnetizable-sheet laminate system wherein such at least one printable laminate layer comprises vinyl.

Even further, it provides such a magnetizable-sheet laminate system wherein such at least one printable laminate layer comprises at least one matte finish. Even further, it provides such a magnetizable-sheet laminate system wherein such at least one printable laminate layer comprises at least one high-gloss finish. Even further, it provides such a magnetizable-sheet laminate system wherein such at least one printable laminate layer comprises at least one gloss finish. Even further, it provides such a magnetizable-sheet laminate system wherein such at least one printable laminate layer comprises at least one wipe-off finish.

In accordance with another preferred embodiment hereof, this invention provides a magnetizable-sheet laminate system comprising: magnetizable-layer means for providing at least one magnetizable laminate layer; printable layer means for providing at least one printable layer; and attacher layer means for attaching such magnetizable-layer means with such printable layer means; wherein such magnetizable-sheet laminate system comprises at least one laminate less than about 20 mils thick. And, it provides for each and every novel feature, element, combination, step and/or method disclosed or suggested by this patent application.

### BRIEF DESCRIPTION OF THE FIGURES

FIG. 1 shows a diagram, illustrating an implementation of preferred magnetic laminate system, according to a preferred embodiment of the present invention.

FIG. 2 shows a perspective view, illustrating at least one preferred roll of preferred magnetic laminate, according to the preferred embodiment of FIG. 1.

FIG. 3 shows an enlarged edge view of magnetic laminate, illustrating the preferred layers of the preferred magnetic laminate, according to the preferred embodiment of FIG. 1.

FIG. 4 shows a diagram, illustrating a preferred batching process, according to the preferred embodiment of FIG. 1.

FIG. 5 shows a diagrammatic front perspective view, illustrating a preferred mixing process using at least one mill, according to the preferred embodiment of FIG. 1.

FIG. 6 shows a side diagrammatic view, illustrating a preferred granulating process in at least one granulator, according to the preferred embodiment of FIG. 1.

FIG. 7 shows a diagrammatic perspective view, illustrating a preferred calendaring process, according to the preferred embodiment of FIG. 1.

FIG. 8 shows a diagrammatic side view, illustrating a preferred flexible magnet laminating process, according to the preferred embodiment of FIG. 1.

### DETAILED DESCRIPTION OF THE BEST MODES AND PREFERRED EMBODIMENTS OF THE INVENTION

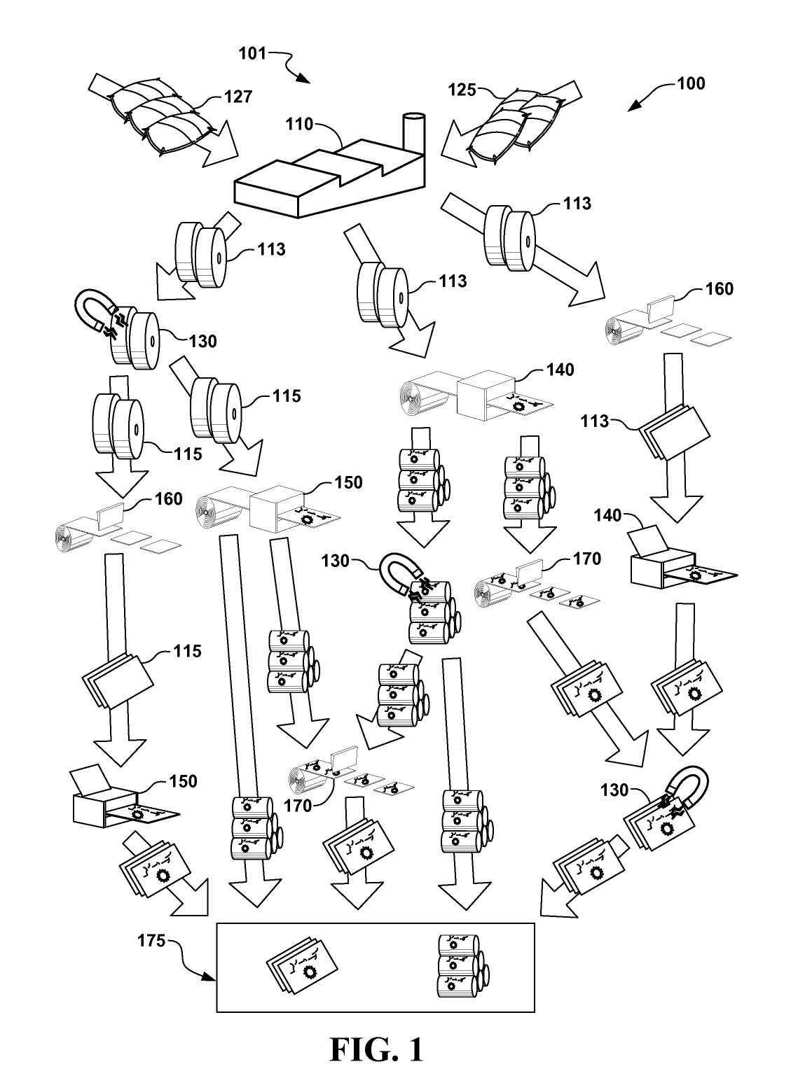

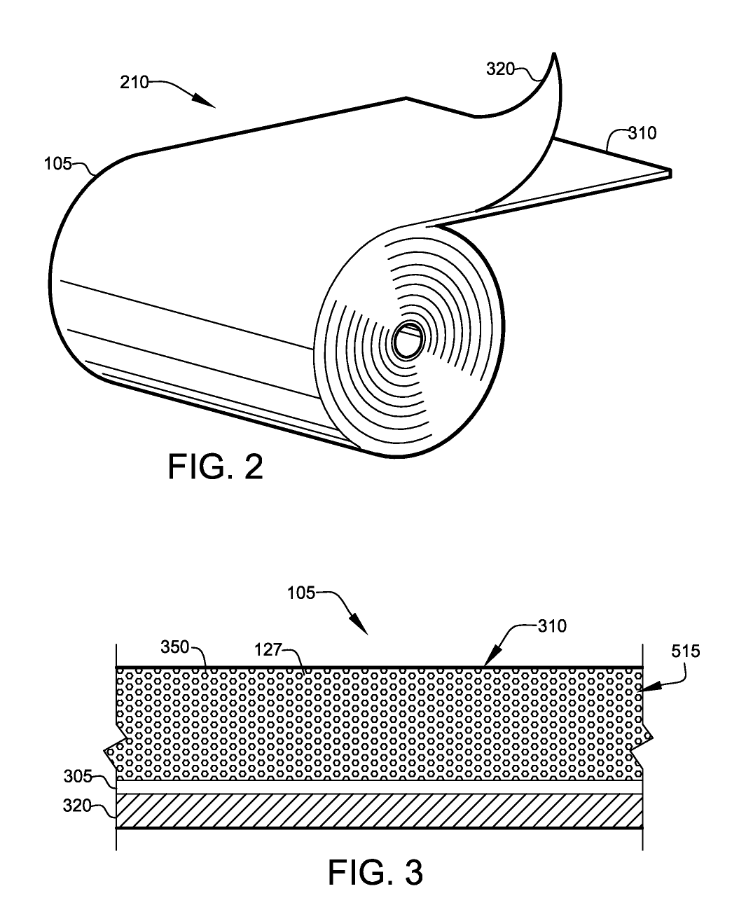

FIG. 1 shows a diagram, illustrating a magnetic laminate system 100, according to a preferred embodiment 101 of the present invention. In preferred embodiment 101 of magnetic laminate system 100 preferably comprises manufacturing and preferably printing of at least one magnetic laminate 105, as shown in FIG. 2 and FIG. 3. Manufacture process 110 (see FIGS. 2-8) of magnetic laminate 105 requires strontium ferrite powder 125 and at least one binder 127, as shown. Magnetic laminate 105 is preferably manufactured non-magnetized. At least one magnetization process 130 preferably occurs to magnetize magnetic laminate 105 after manufacture, as shown.

Some printing processes 140, usually due to hardware limitations, are inhibited in the presence of a magnetic field. When magnetic laminate 105 is printed by printing processes 140, preferably, non-magnetized magnetic laminate 113, comprising magnetic laminate 105 that is not magnetized, is used and magnetization process 130 occurs after printing processes 140, as shown. Magnet-friendly printing processes 150, however, are preferably capable of accepting magnetized magnetic laminate 115, comprising magnetic laminate 105 that is magnetized, and, therefore, magnetization process 130 may preferably occur before magnet-friendly printing processes 150, as shown.

As shown, cutting of magnetic laminate 105 in preprinting cutting process 160 preferably sizes magnetic laminate 105 to accommodate printing processes 140 and magnet-friendly printing processes 150, preferably with acceptable media sizes. Such acceptable media sizes may preferably include letter, legal, A4, 25-foot roll, etc. Post-printing cutting processes 170 preferably cut magnetic laminate 105 into at least one final size of at least one finished magnetic laminate product 175, as shown. Finished magnetic laminate product 175 preferably comprises magnetic business cards, alternately preferably signs, alternately preferably banners, alternately preferably logos, alternately preferably accessories, alternately preferably figures, alternately preferably labels. Upon reading this specification, those with skill in the art will now appreciate that, under appropriate circumstances, considering such issues as future indicia displays, use of magnetically attractive surfaces, etc., other finished magnetic laminate products, such as, for example, vehicle wraps, appliance decor, advertising billboards, etc., may suffice.

FIG. 2 shows a perspective view, illustrating at least one roll 210 of magnetic laminate 105, according to the preferred embodiment of FIG. 1. As shown, roll 210 preferably comprises at least one length of magnetic laminate 105 preferably between about 25 feet and about 1800 feet. Width of roll 210 preferably comprises about 2 feet.

FIG. 3 shows an enlarged edge view of magnetic laminate 105, illustrating the layers of magnetic laminate 105, according to the preferred embodiment of FIG. 1. Magnetic laminate 105 preferably comprises at least one flexible magnet 310 and preferably at least one printable material 320, as shown. Flexible magnet 310 and printable material 320 are preferably laminated together to form magnetic laminate 105, preferably using at least one adhesive 305, as shown. In order to pass through most printers, overall thickness of magnetic laminate 105 preferably comprises less than about 20 mils (about 0.020 inches), preferably less than about 15 mils (about 0.015 inches). Flexible magnet 310 preferably comprises a thickness of less than 15 mils (this arrangement at least embodying herein wherein such at least one homogenous sheet comprises at least one thickness less than about 15 mils thick; and this arrangement at least embodying herein wherein said at least one magnetizable laminate layer comprises at least one thickness less than about 15 mils thick).

Flexible magnet 310 preferably comprises at least one homogenous material 515, as shown, preferably comprising at least one binder 127 and preferably at least one plurality of ferrous particles 350. Ferrous particles 350 comprise preferably ferrite particles, preferably strontium ferrite particles, preferably high-energy strontium ferrite particles (SrFe₁₂O₁₉). High-energy refers to the potential of a magnetizable material to exceed about one million Gauss-Oersted, commonly referred to as Megagauss Oersted (“MGOe”), in magnetic energy, once magnetized (this arrangement at least embodying herein wherein such at least one plurality of magnetizable particles when magnetized comprise a magnetic energy of greater than one Megagauss Oersted). Upon reading this specification, those skilled in the art will now appreciate that, under appropriate circumstances, considering such issues as cost, available materials, etc., other than ferrous particles exhibiting magnetic qualities, such as, for example, non-ferrous magnetic metals, non-ferrous magnetic metal alloys, non-ferrous magnetic compounds, etc., may suffice.

Ferrous particles 350 preferably comprise less than about 20 nanometers each in diameter. Ferrous particles 350 preferably comprise about 91%, by weight, of homogeneous material 515.

Binder 127 comprises preferably Hypalon 45 (chlorosulfonated polyethylene rubber), preferably polyisobutylene (—(CH₂—C₃H₆)n-), and preferably ethylene vinyl acetate (CH₃COOCH═CH₂). By weight of homogeneous material 515: Hypalon 45 preferably comprises about 3.6%; polyisobutylene preferably comprises about 3%; and ethylene vinyl acetate preferably comprises about 2.2%. Upon reading this specification, those skilled in the art will now appreciate that, under appropriate circumstances, considering such issues as cost, future technology, etc., other binder materials, such as, for example, resins, other plastics, etc., may suffice.

When magnetized, flexible magnet 310 preferably comprises a magnetic energy of at least 1.0 MGOe (Megagauss Oersted), preferably about 1.7 MGOe. When magnetized, flexible magnet 310 preferably comprises through-width magnetization, alternately preferably through-thickness magnetization. Upon reading this specification, those skilled in the art will now appreciate that, under appropriate circumstances, considering such issues as, application, magnetization methods, cost, etc., other magnetizations, such as, for example, multi-pole magnetization, double-sided magnetization, match-pole magnetization, two poles on each face magnetization, etc., may suffice.

Printable material 320 preferably comprises plastic, preferably vinyl. Upon reading this specification, those skilled in the art will now appreciate that, under appropriate circumstances, considering such issues as application, cost, available materials, etc., other printable materials, such as for example, cloth, paper, other plastics, etc., may suffice.

Printable material 320 comprises preferably a matte finish, alternately preferably a gloss finish, alternately preferably a high-gloss finish, alternately preferably a wipe-off finish. For best printing quality, the finish is chosen to preferably compliment the printer in which magnetic laminate 105 is printed. Upon reading this specification, those skilled in the art will now appreciate that, under appropriate circumstances, considering such issues as application, cost, available materials, etc., other finishes, such as for example, textured, patterned, antique, etc., may suffice.

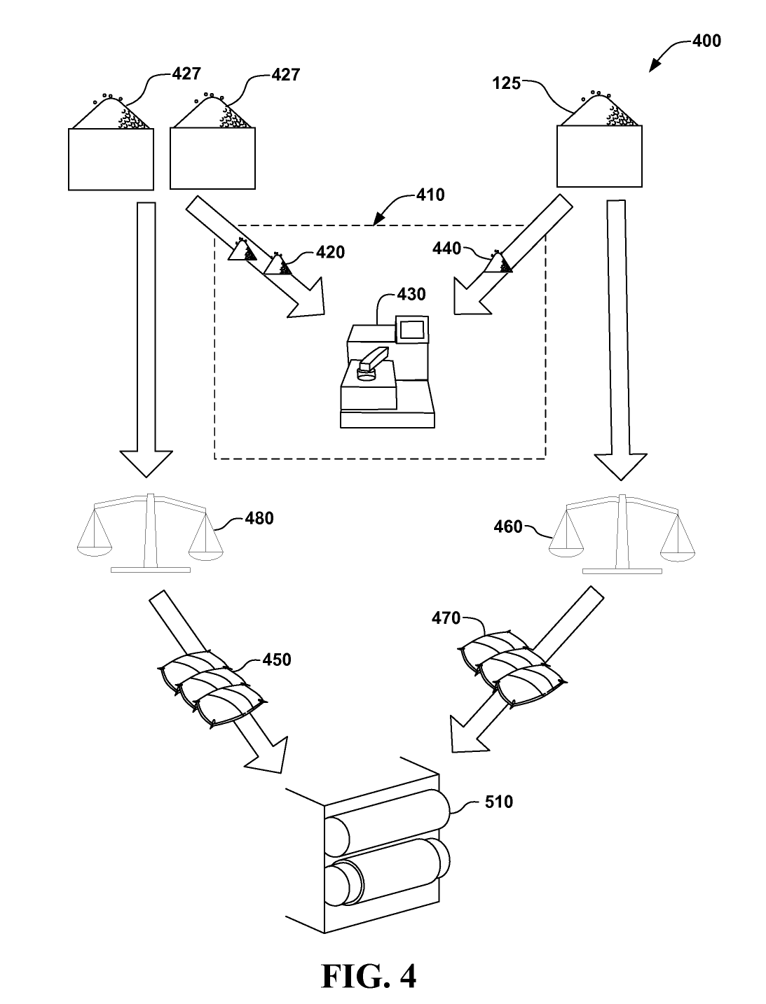

FIG. 4 shows a diagram, illustrating a batching process 400, according to the preferred embodiment of FIG. 1. Flexible magnet 310 preferably is a careful balance of flexibility and magnetic strength. To achieve flexibility, at least one binder component 427 is preferably bound with ferrous particles 350 to form flexible magnet 310, as shown in FIG. 3. Flexible magnet 310 is preferably smooth, preferably flat, preferably flexible and preferably easily cut. To achieve this, each binder component 427 is preferably weighed for an optimal blend to make flexible magnet 310. If the weight of each binder component 427 is not correct, it can cause the sheet to be brittle, magnetically weak, or hard to cut or process.

At the beginning of batching process 400, preferably, at least one incoming quality inspection process 410 occurs, as shown. In incoming quality inspection process 410, preferably, at least one sample 420 of each binder component 427 and, preferably, at least one sample 440 of strontium ferrite powder 125 are scanned through a Differential Scanning Calorimeter 430, as shown, preferably to ensure that the molecular characteristics of the materials are consistent with established standards. The molecular characteristics from binder materials used in the past with a proven performance curve are preferably used as a benchmark for the new incoming binder materials to meet or exceed. Additionally, sample 440 of strontium ferrite powder 125 is preferably checked for particle size, to assure proper magnetic characteristics, using Differential Scanning Calorimeter 430, as shown.

After incoming quality inspection process 410, binder components 427 preferably undergo a weighing and bagging process 480 preferably resulting in at least one bag of binder mix 450, as shown. A plurality of bags of binder mix 450 is then preferably transported to at least one mill 510, as shown, for mixing with strontium ferrite powder 125.

Likewise, strontium ferrite powder 125 preferably undergoes a weighing and bagging process 460 resulting in at least one 50-pound bag 470, as shown. A plurality of 50-pound bags 470 are then preferably transported to mill 510, as shown.

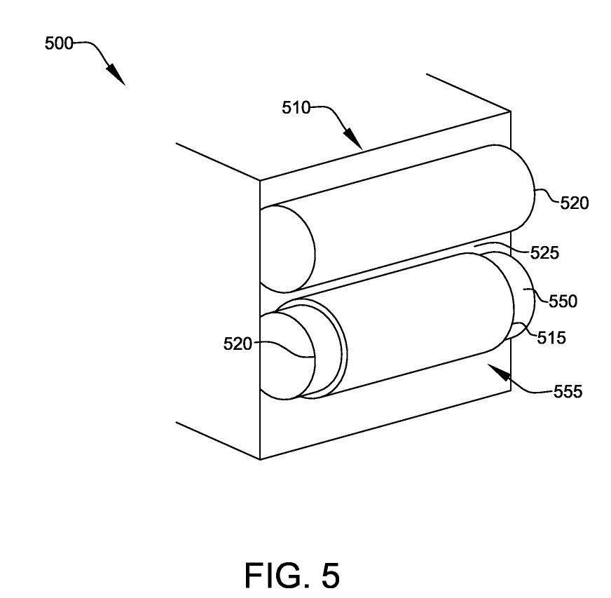

FIG. 5 shows a diagrammatic front perspective view, illustrating mixing process 500 using mill 510, according to the preferred embodiment of FIG. 1. Preferably, mill 510 mechanically mixes binder 127 and strontium ferrite powder 125 together into a homogeneous material 515. Using pressure, friction and heat, mill 510 preferably creates a consistent blend throughout homogeneous material 515.

Mixing process 500 preferably begins with loading binder mix 450 onto at least two cylindrical rolls 520 of mill 510. Cylindrical rolls 520 preferably transfer heat to binder mix 450 through at least one roll face 550 and preferably through pressure at the nip 525, as shown, where such at least two cylindrical rolls are closest. The pressure and heat at nip 525 preferably cause binder mix 450 to break down and form binder 127 (at least embodying herein wherein such at least one magnetizable laminate layer comprises at least one binder material structured and arranged to bind together components of such at least one magnetizable laminate layer). Binder 127 preferably melts and preferably adheres to such at least one roll face 550 in a semi-smooth coating 555, as shown.

At this point, binder 127 is preferably ready to receive ferrous particles 350. Strontium ferrite powder 125, preferably comprising ferrous particles 350 (at least embodying herein wherein such at least one plurality of magnetizable particles consist essentially of strontium ferrite), is preferably added to mill 510 and ferrous particles 350 (at least embodying herein at least one plurality of magnetizable particles held by such at least one binder material) preferably embed into binder 127 (at least embodying herein at least one binder material structured and arranged to bind together components of such at least one homogenous sheet). Mill 510 preferably mixes binder 127 and ferrous particles 350, preferably forming homogeneous material 515.

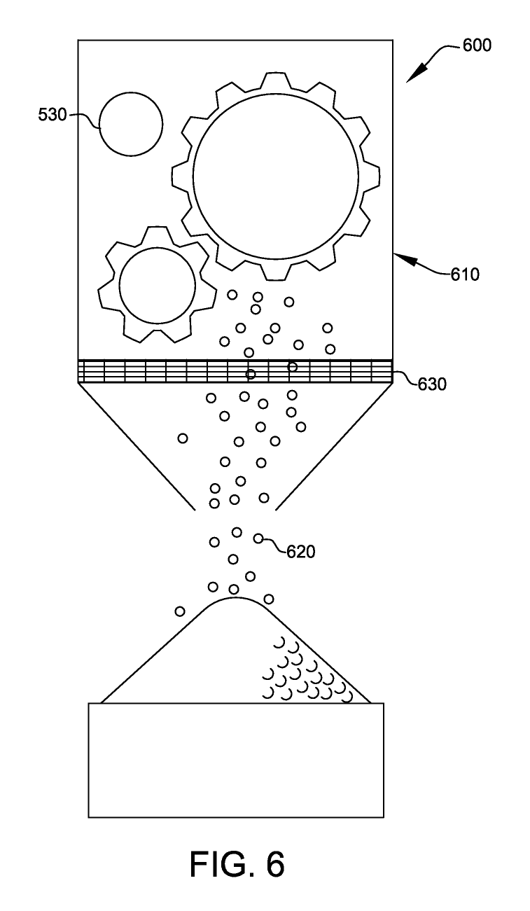

Once ferrous particles 350 are properly dispersed, homogeneous material 515 is preferably removed from mill 510 in small rolls of homogeneous material 515, commonly known as pigs 530 in the art, which are preferably fed to at least one granulator 610, as shown in FIG. 6.

FIG. 6 shows a side diagrammatic view, illustrating granulating process 600 in granulator 610, according to the preferred embodiment of FIG. 1. Pigs 530 of homogeneous material 515, coming from mill 510, preferably are next granulated, as shown. Particle size is critical to maintaining smoothness in finished magnetic laminate product 175 and processability in calendaring process 700. At least one granulator 610 preferably cuts pigs 530 into granular particles 620 and preferably forces granular particles 620 through at least one sizing screen 630, as shown. Granular particles 620 preferably are then ready for use in calendaring process 700.

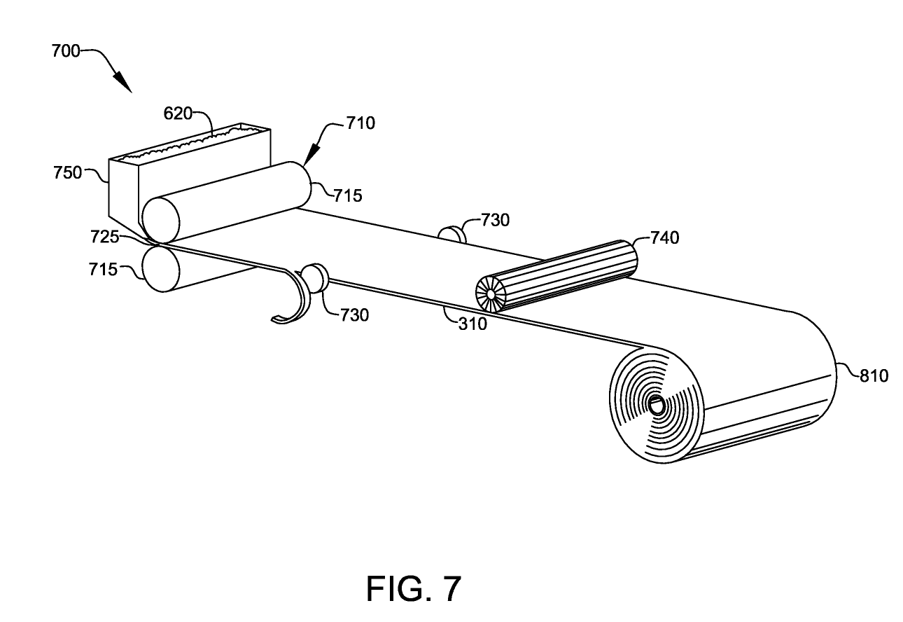

FIG. 7 shows a diagrammatic perspective view, illustrating calendaring process 700, according to the preferred embodiment of FIG. 1. During calendaring process 700, homogeneous material 515 preferably becomes flexible magnet 310, as shown. As shown, granular particles 620 are preferably forced through a calendaring nip 725 of at least one calendar 710 and preferably bound into a sheet with a predetermined thickness and width.

Granular particles 620 are preferably fed into calendar 710 from granular particle bin 750, as shown, preferably making sure the profile of flexible magnet 310 is consistent by evenly distributing granular particles 620 through calendaring nip 725. Any contaminants contained in granular particles are preferably removed before feeding into calendaring nip 725. At least one quality-check preferably ensures the quality of flexible magnet 310 in terms of thickness, width, smoothness and cleanliness.

Flexible magnet 310 preferably comprises a smooth finish for optimal use in printing processes 140 and magnet-friendly printing processes 150. Problems in quality may result in poor ink adhesion, poor ink coverage and voids where ink will not go down because of blisters, zits, or a generally grainy texture.

The profile of flexible magnet 310 is preferably flat. With inconsistencies in thickness, flexible magnet 310 will not lay flat when finished. Consistent thickness is preferably achieved by careful management of calendaring nip 725, the temperature of calendar rolls 715 and the shape of calendar rolls 715. Calendar rolls 715 preferably maintain an even temperature, preferably as well as a smooth circular-cylinder surface. Calendaring nip 725 preferably maintains a consistent gap between calendar rolls 715.

The thickness of flexible magnet 310 is set and maintained preferably by managing calendaring nip 725 between the calendar rolls. While moving therethrough, flexible magnet 310 is preferably checked often to insure that the thickness is consistent, preferably both across the profile of flexible magnet 310 and throughout the length of the run.

The width of flexible magnet 310 is preferably controlled by at least one rotating cutter 730, as shown, that is set up to preferably trim flexible magnet 310 to at least one precise width. As shown, at least one nylon rotary brush 740 is preferably used to ensure that loose particles and other contaminants are preferably not wound up with flexible magnet 310 at the end of calendaring process 700.

During calendaring process 700, the magnetic characteristics, smoothness and thickness of flexible magnet 310 are preferably optimized and fixed and therefore cannot be modified later without destroying flexible magnet 310.

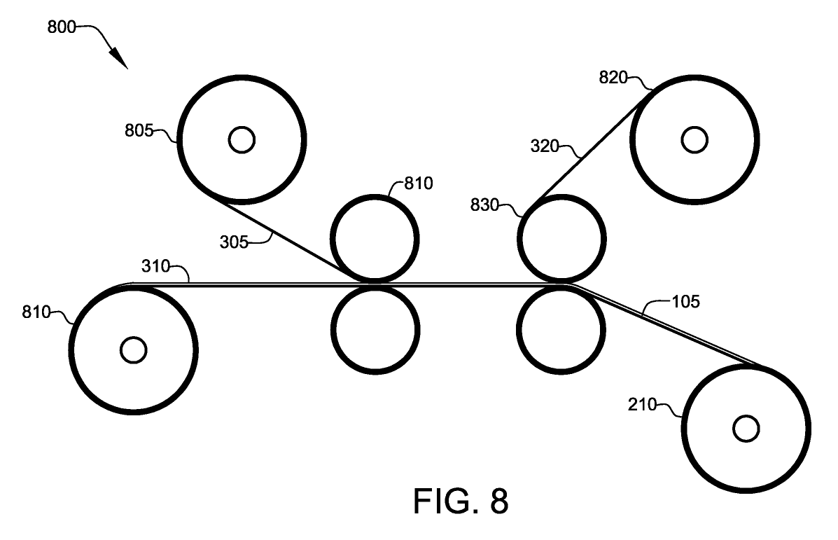

FIG. 8 shows a diagrammatic side view, illustrating a preferred flexible magnet laminating process 800, according to the preferred embodiment of FIG. 1.

At least one lamination process 880 preferably comprises at least one roll 810 of flexible magnet 310, preferably at least one roll 805 of adhesive 305, and preferably at least one roll 820 of printable material 320, as shown.

Flexible magnet 310 is preferably fed into lamination process 800 where adhesive application roller 810 preferably applies adhesive 305 (at least embodying herein at least one attacher laminate layer structured and arranged to attach such at least one magnetizable laminate layer with such at least one printable laminate layer) to flexible magnet 310 (at least embodying herein at least one magnetizable laminate layer), as shown. Printable material 320 (at least embodying herein at least one printable laminate layer) preferably is then applied by at least one printable material application roller 830 onto adhesive 305.

Adhesive 305 preferably is heated to activate adhesive qualities. After adhesive 305 cools and lamination is set, magnetic laminate 105 is preferably rolled up forming roll 210 (at least embodying herein wherein such at least one laminate comprises at least one roll), as shown.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A magnetizable-sheet laminate system comprising:
a) at least one magnetizable laminate layer;
b) at least one printable laminate layer; and
c) at least one attacher laminate layer structured and arranged to attach said at least one magnetizable laminate layer with said at least one printable laminate layer;
d) wherein said magnetizable-sheet laminate system comprises at least one laminate less than about 20 mils thick.

2) The magnetizable-sheet laminate system according to claim 1 wherein said at least one magnetizable laminate layer comprises at least one thickness less than about 15 mils thick.

3) The magnetizable-sheet laminate system according to claim 1 wherein said at least one laminate comprises at least one width of about two feet.

4) The magnetizable-sheet laminate system according to claim 1 wherein said at least one laminate comprises at least one roll.

5) The magnetizable-sheet laminate system according to claim 1 wherein said at least one magnetizable laminate layer comprises strontium ferrite.

6) The magnetizable-sheet laminate system according to claim 6 wherein said at least one magnetizable laminate layer, by weight, comprises about 91% strontium ferrite.

7) The magnetizable-sheet laminate system according to claim 1 wherein said at least one magnetizable laminate layer comprises at least one binder material structured and arranged to bind together components of said at least one magnetizable laminate layer.

8) The magnetizable-sheet laminate system according to claim 7 wherein said at least one binder material comprises:
a) chlorosulfonated polyethylene rubber;
b) polyisobutylene; and
c) ethylene vinyl acetate.

9) The magnetizable-sheet laminate system according to claim 1 wherein said at least one printable laminate layer comprises vinyl.

10) The magnetizable-sheet laminate system according to claim 1 wherein said at least one printable laminate layer comprises at least one matte finish.

11) The magnetizable-sheet laminate system according to claim 1 wherein said at least one printable laminate layer comprises at least one high-gloss finish.

12) The magnetizable-sheet laminate system according to claim 1 wherein said at least one printable laminate layer comprises at least one gloss finish.

13) The magnetizable-sheet laminate system according to claim 1 wherein said at least one printable laminate layer comprises at least one wipe-off finish.

14) A magnetizable-sheet system comprising:
a) at least one homogenous sheet comprising
i) at least one binder material structured and arranged to bind together components of said at least one homogenous sheet, and
ii) at least one plurality of magnetizable particles held by said at least one binder material,
iii) wherein said at least one plurality of magnetizable particles consist essentially of strontium ferrite, and
iv) wherein said at least one plurality of magnetizable particles, when magnetized, comprise a magnetic energy of greater than about one Megagauss Oersted.

15) The magnetizable-sheet system according to claim 14 wherein said at least one homogenous sheet comprises at least one thickness less than about 15 mils thick.

16) The magnetizable-sheet system according to claim 14 wherein said at least one binder material comprises:
a) chlorosulfonated polyethylene rubber;
b) polyisobutylene; and
c) ethylene vinyl acetate.

17) The magnetizable-sheet system according to claim 16 wherein said at least one binder material, by weight of said at least one homogeneous sheet, comprises:
a) about 3.6% chlorosulfonated polyethylene rubber;
b) about 3% polyisobutylene; and
c) about 2.2% ethylene vinyl acetate.

18) The magnetizable-sheet system according to claim 14 wherein said at least one homogeneous sheet, by weight, comprises about 91% strontium ferrite.

19) A magnetizable-sheet laminate system comprising:
a) at least one magnetizable laminate layer comprising
i) at least one binder material structured and arranged to bind together components of said at least one magnetizable laminate layer, and
ii) at least one plurality of magnetizable particles held by said at least one binder material,
iii) wherein said at least one plurality of magnetizable particles consist essentially of strontium ferrite, and
iv) wherein said at least one plurality of magnetizable particles, when magnetized, comprise a magnetic energy of greater than one Megagauss Oersted;
b) at least one printable laminate layer; and
c) at least one attacher laminate layer structured and arranged to attach said at least one magnetizable laminate layer with said at least one printable laminate layer;
d) wherein said magnetizable-sheet laminate system comprises at least one laminate less than about 20 mils thick;
e) wherein said at least one magnetizable laminate layer comprises at least one thickness less than about 15 mils thick.

20) The magnetizable-sheet laminate system according to Claim wherein said at least one magnetizable laminate layer, by weight, comprises:
a) about 3.6% chlorosulfonated polyethylene rubber;
b) about 3% polyisobutylene;
c) about 2.2% ethylene vinyl acetate; and
d) about 91% strontium ferrite.
